(19) United States
(12) Patent Application Publication
(10) Pub. No.: US 2012/0279479 A1
(43) Pub. Date: Nov. 8, 2012

(54) Heat Recycling Internal Combustion Enines

(76) Inventor: William A. Kelley, Austin, TX (US)

(21) Appl. No.: 13/103,074

(22) Filed: May 8, 2011

(51) Int. Cl. F02B 75/40

(52) U.S. Cl. 123/51 R

(57) ABSTRACT

This patent describes two engine designs capable of recycling waste heat. The engines are both theoretically capable of approaching 100% efficiency in converting fuel to motion, although they use the same thermodynamic cycle as much lower efficiency 4 stroke engines.

Also described is a device to complete combustion of carbon monoxide into CO2 while recycling the chemical energy, the Carbon Monoxide Afterburner/Heat Exchanger (CMAHE).

Engines use devices from patents pending with attorney docket number wakelley01, wakelley02 and wakelley03.

The first engine is named the “Balanced Load” engine or BL engine, the second the “Kinetic Load Engine” or KₑLₗE_{y}

Engines use a device, Thermal Pressure Multiplier, to reclaim heat. Air is compressed, then preheated to set pre-combustion conditions at a higher temperature and pressure. Engines use type of heat exchangers with a theoretical maximum temperature and heat exchange of 100%.

### CROSS-REFERENCE TO RELATED APPLICATIONS

References patents pending with attorney docket number wakelley01, wakelley02 and wakelley03, cited below as Patent A, Patent B, and Patent C, respectively.

### STATEMENT REGARDING FEDERALLY SPONSORED RESEARCH AND DEVELOPMENT

This patent is not federally sponsored.

### REFERENCE TO SEQUENCE LISTING, A TABLE, OR A COMPUTER PROGRAM LISTING COMPACT DISC APPENDIX

Not applicable.

### BACKGROUND OF THE INVENTION

Most current automotive engines are 4 cycle internal combustion engines, also known as 4 stroke engines. 4 cycle engines are characterized by 4 strokes, air intake, compression, power, and exhaust. These are done in each cylinder. Here are defined two new engine types, which achieve the same end result, but have different cycles, although they are both piston based engines.

The first is named the “Balanced Load” engine or BL engine. It has the same number of cylinders as the 4 stroke engine, but half the cylinders are only power/exhaust stroke cylinders and the other half only do intake/compression. It will have the same number of cylinders as a comparably powered 4 stroke engine.

The second is named the “Kinetic Load Engine” or KₑLₗE_{y} It also removes the compression/intake cycle from the power cylinders, but does not have corresponding compression cylinders. It will have half the number of cylinders as a comparably powered 4 stroke engine.

The details section will describe the differences of the two engine types and how each functions.

The devices in this patent build on the Low Cost Exhaust Heat Exchanger (LCEHE) and automotive embodiments in Patent A, The Fluid Pressure Ladder (FPL) in Patent B, and The Thermal Pressure Multiplier (TPM) and Pressure Transfer Piston (PTP) in Patent C.

A note on 4 stroke engine operation. Grade school teaches that piston engines are powered by tiny explosions. Gives images of tremendous heat and pressure too dangerous to be inside anything but a massive metal block. The heat and pressure inside an internal combustion engine are typically what arise from a compression ratio of 10, and a maximum temperature rise of about 900 degrees C. That temperature rise results in a final temperature of about 4 times ambient absolute temperature. Ideal gas laws put the pressure rise at the same factor of 4. So engine temperatures are less than most commonly used metal's melting point, and maximum pressure about 40 Atmospheres, or 600 psi. Those pressures are typical for modern air conditioning systems, and can be handled by copper and aluminum tubing. Contrary to the mental image of explosive pressures, the pressures are easily handled by pneumatic hardware. High pressure also makes movement of air much easier than a pressure difference of a fraction of an Atmosphere, transit times through valves faster, chemical reactions faster. Pressurized air solves many more engine problems than it creates.

### BRIEF SUMMARY OF THE INVENTION

The following will describe two engine designs capable of recycling waste heat. The engines are both theoretically capable of approaching 100% efficiency in converting fuel to motion, although they use the same thermodynamic cycle as a 4 stroke engine.

Also described is a device to complete combustion of carbon monoxide into CO2, while recovering the chemical energy released to be recycled into useful work, the Carbon Monoxide Afterburner/Heat Exchanger (CMAHE).

### BRIEF DESCRIPTION OF THE SEVERAL VIEWS OF THE DRAWING

FIG. 1 shows- a Thermal Pressure Multiplier or TPM (from patent C), with a single stage Fluid Pressure Multiplier or FPL (from patent B). It shows as heat exchanger stage of the TPM, a CO afterburner or CMAHE, described in greater detail following. The engine shown is the BL engine, with 4 cylinders, also described in greater detail following. It is a minimal change from a 4 stroke engine, so is shown first in the figures. Shown here is not an ideal embodiment, rather an embodiment closest to existing proven 4 stroke engines, to minimize risk and time to market. This emodiment is limited to equalizing temperature between working fluid and exhaust, as this is not a counter flow heat exchanger, which could exchange temperatures of the two fluids. Consequently, it has an inherent limit of recovering half the heat exhausted.

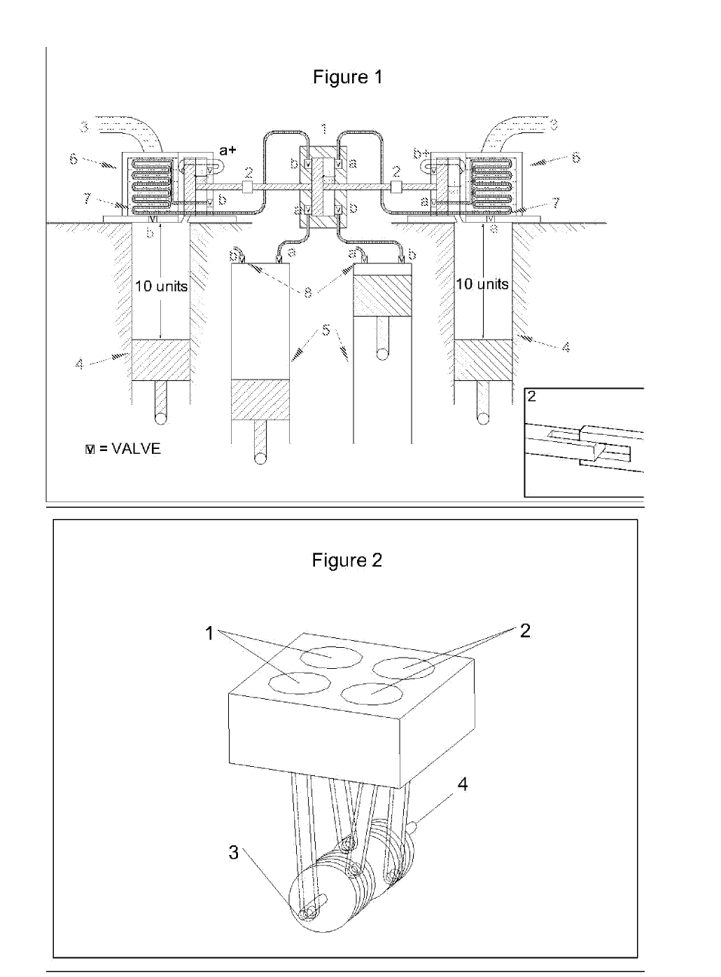

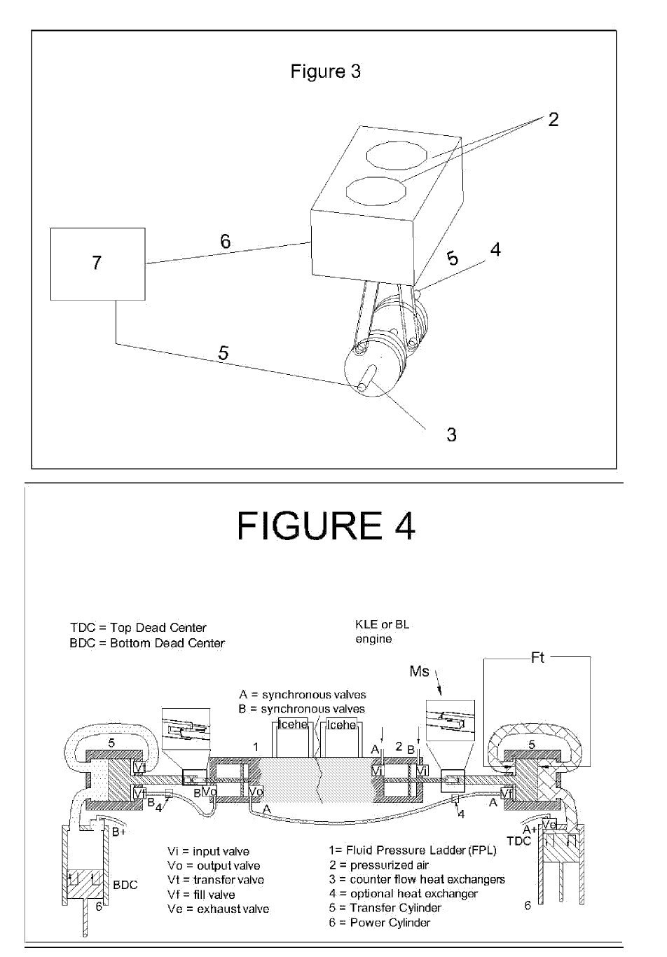

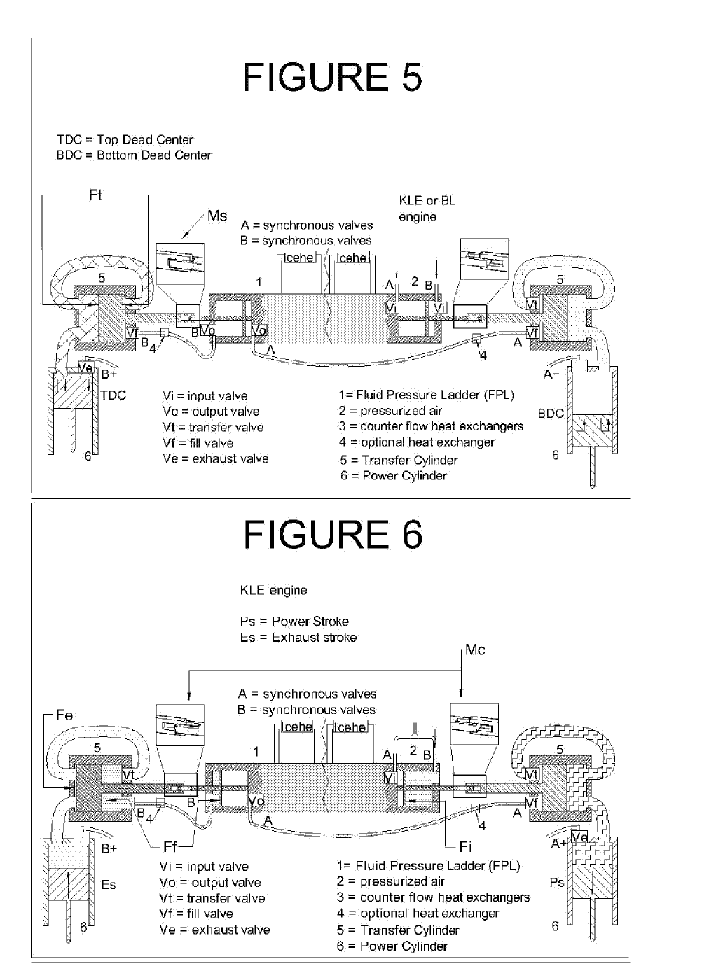

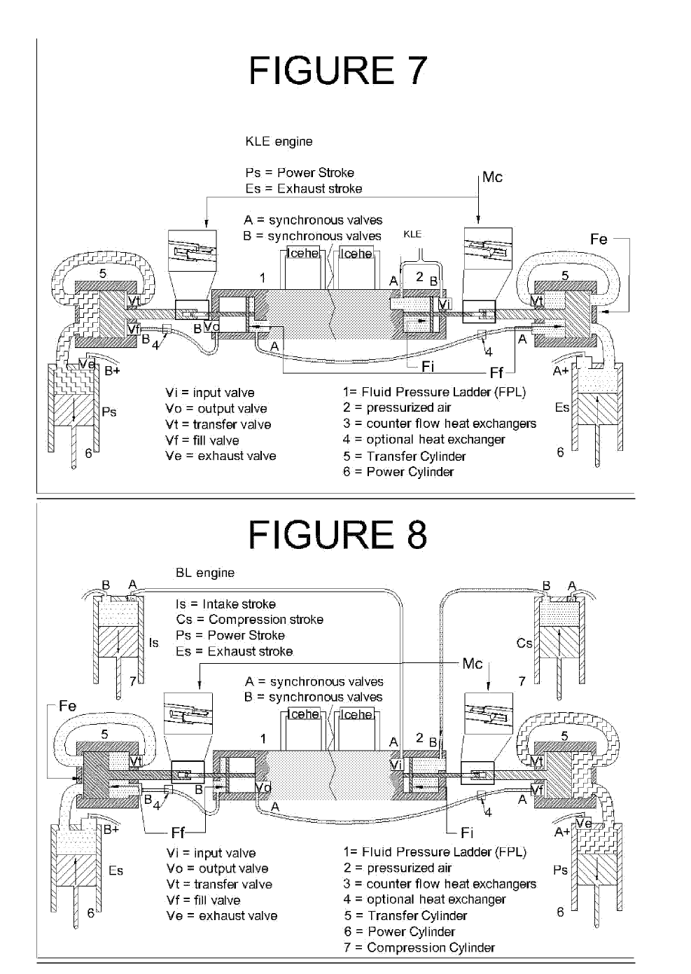

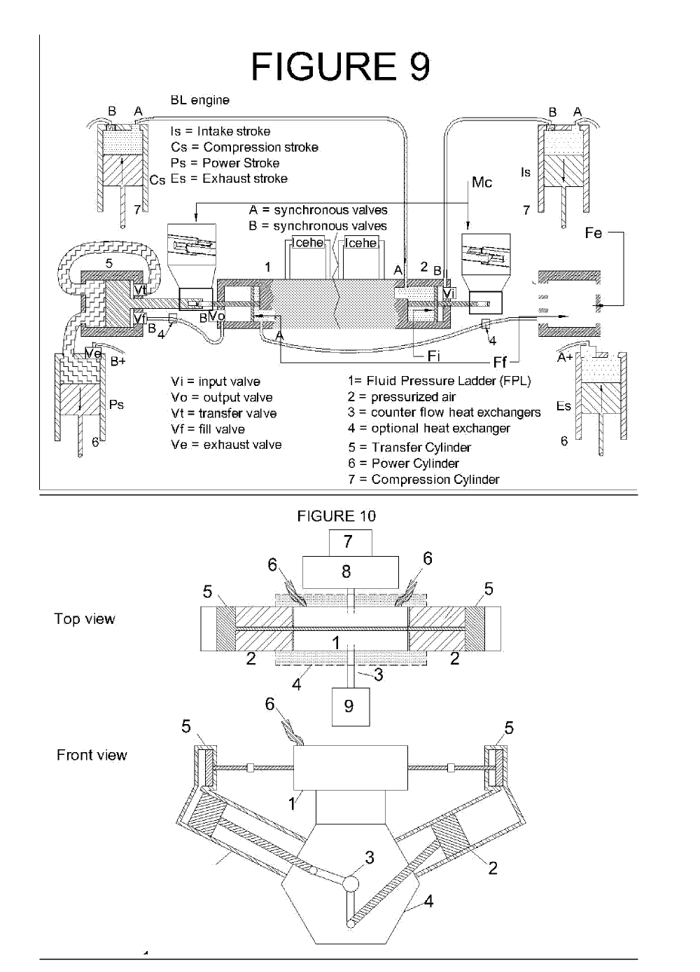

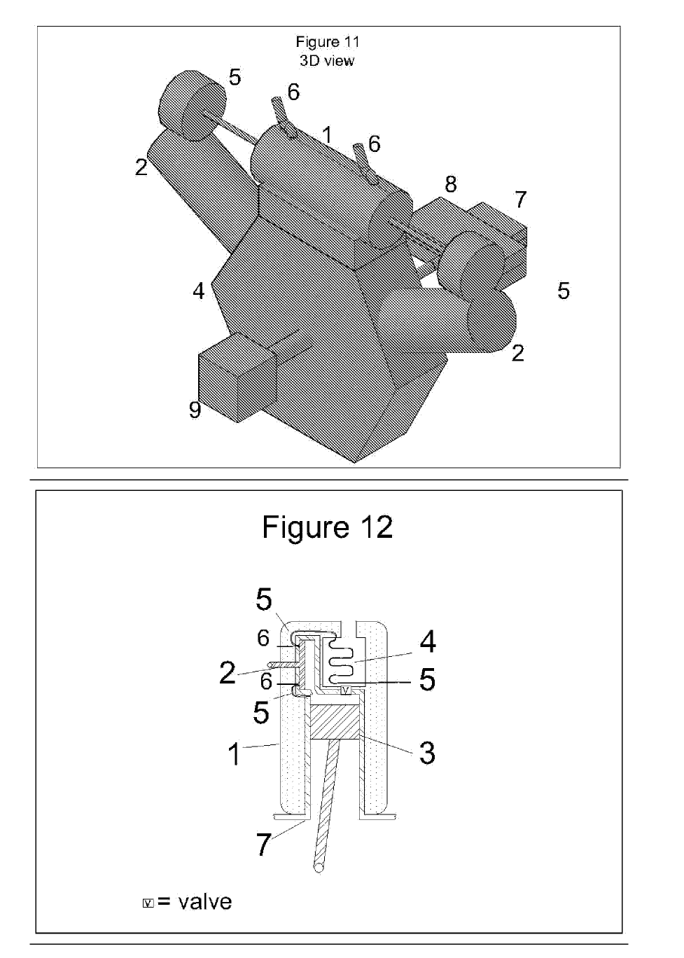

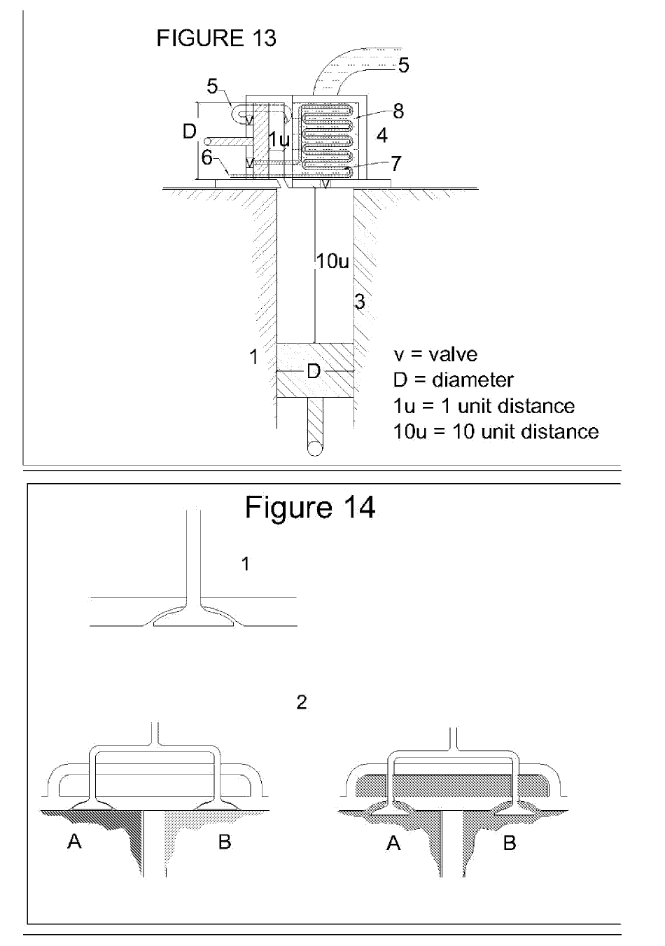

In FIG. 1, A and B each denote synchronous valve sets, A+ is a valve that can be open during the A valve cycle, but should begin opening slightly sooner. B+ similarly denotes opening sooner than B valves. 1=Single Stage FPL, 2=Connecting rod with slip coupling, 3=cylinder/CMAHE exhaust, 4=Power cylinders and pistons, 5=Compression cylinders and pistons, 6=Combination CMAHE and TPM/PTP, 7=Compressed air flows through CMAHE from TPM/FPL (originally from a compression cylinder) into TPM/PTP. 8=atmospheric intake, V=valve.

CMAHE allows unburned hydrocarbons and CO to complete combustion, assisted as needed inside CMAHE with catalyst, similar to found in catalytic converters. This additional combustion raises heat of exhaust, which is transferred in part to incoming compressed air. Incoming compressed air is heated up to about ½ the temperature rise of the Cylinder exhaust above ambient temperature. This increases the pressure the power cycle begins with, so that fuel required to reach desired post Power stroke combustion temperature and pressure is reduced. In other words, part of the Power strokes pressure is derived from the previous Power strokes heat.

FIG. 2 shows the Balanced Load engine or BL engine block and crankshaft, which is identical to a 4 stroke block and crankshaft. The difference lies above the block, in only using half the cylinders for power/exhaust strokes, the other half for compression/intake strokes. The TPM system accepts air during the compression stroke which will be compressed to the engine compression ratio, just as in a 4 stroke engine. The completed compression stroke will come close to voiding the cylinder, rather than have approximately cylinder volume divided by compression ratio volume left. The air volume is moved to the intake stage of the TPM (FPL), moving the connected series of compressed air pistons to the opposite fill side, and pressurizing and filling the PTP of the Power cylinder paired to this Compression cylinder. Each compression cylinder acts to fill a specific Power cylinder. Should more than two power cylinders be needed, the simplest design would change to 4 power cylinders, not 3. BL engines are most naturally 4, 8 or 12 total cylinders in their simplest implementation.

FIG. 3 is again a block diagram of the Kinetic Load Engine or KLE. It has no compression cylinders, instead has an external compression device. High end compressors are never implemented as single stage piston compressors. They are multi stage piston, scrolling or rotary compressors. For a given horsepower driving a compressor, these designs are smaller, quieter, and produce a higher volume of compressed air. Power strokes per revolution of a 2 cylinder KLE are the same as a 4 cylinder 4 stroke engine. A 2, 4 or 6 cylinder KLE is comparable to a 4, 8 or 12 cylinder 4 stroke. Although the displaced volume of the engine is half the 4 stroke's, the number of Power strokes per revolution is the same, and the power stroke cylinders and pistons the same. A 4 cylinder 4 stroke block could be used to create a KLE equivalent of an 8 cylinder 4 stroke engine. However, a block is only needed to provide a rigid platform and to provide for water cooling. An ideal embodiment will treat heat as fuel, and prevent heat loss everywhere possible. Heat good, water cooling bad. An aircraft radial piston arrangement is more suitable when the block is abandoned, or a V arrangement inspired by the radial piston arrangement. This will be shown later.

For FIGS. 4, 5, 6, 7, 8 and 9: Vi=TPM/FPL input valve, Vo=FPL output valve, Vf=TPM/PTP fill valve, Vt=TPM/PTP transfer valve, Ve=Power Cylinder exhaust valve. 1=FPL, 2=pressurized air source, 3=LCEHE, 4=optional heat exchanger between FPL and PTP. While not shown, an ideal embodiment would have the CMAHE located at position 4, to recover wasted exhaust chemical energy. A=set of synchronous valves to fill one TPM/PTP, and B=set of synchronous valves to fill the opposite TPM/PTP. Ms=mechanical slip during TPM/PTP transfer stroke, Fi=Force due to input pressure of TPM/FPL, Ff=balanced forces due to TPL/FPL output pressure and TPM/PTP fill pressure, Fe=Force on TPM due to exhaust pressure and Ft=Force on TPM/PTP transfer piston during transfer stroke. Ps=Power stroke, Es=Exhaust stroke, Is=intake stroke, Cs=compression stroke. LCEHE=Low Cost Exhaust Heat exchanger (from Patent A). TPM and PTP are from Patent C, FPL is from Patent B. Fuller descriptions of the operations of the TPM and its sub-devices are in Patent A, Patent B and Patent C.

FIGS. 4, 5, 6 and 7 show a block diagram of a multi-stage TPM for a Kinetic Load Engine. FIGS. 4 and 6 show the PTP transfer stroke initiating the power cylinders Power stroke, and its opposite. FIGS. 5 and 7 show a Fill stroke of the TPM's FPL and PTP, and its opposite.

FIGS. 8 and 9 show the strokes relative timing. These figures are for a BL engine, hence show the Compression Cylinders. The KLE is identical sequence, except there are no Compression Cylinders. The Power stroke can begin immediately after initiating the Transfer stroke, as the compressed air is injected into the combustion space. Increased pressure due to combustion will only speed the transfer cycle. A Power stroke of one Power cylinder should occur at the same time the Exhaust stroke occurs in its opposing cylinder. This allows the TPM, FPL and PTP to perform the PTP fill stroke during the exhaust stroke.

FIGS. 10 and 11 are for a KLE embodiment with separate Power cylinder containers, as opposed to the cylinders being in the same block. Placing the TPM between the Power Cylinder heads creates a roughly triangular arrangement, but there is still some flexibility in the direction of the Power cylinders relative to the crank case, length of connecting rod, etc. 1=FPL, 2=Power Cylinder and piston, 3=crank shaft, 4=crank case, 5=PTP, 6=tubing connecting LCEHE and FPL stages, 7=small electric motor to pressurize air input prior to ignition, 8 =compressor mechanism, driven by KLE or by #7, 0=transmission mechanism.

FIG. 12 shows a separate cylinder/piston assembly with thermal insulation. 1=insulation, 2=connecting rod, FPL to PTP, 3=Power piston, 4=CMAHE, 5=internal air paths, for transfer and for connecting CMAHE between FPL and PTP, 6=valves to control Transfer and Fill of PTP, 7=crankcase connection. The inside of the insulation can reach several times ambient temperature, but fuel control and thermodynamic cooling will keep this stable. The Power piston crank shaft rod ideally will provide for some thermal isolation, so that crankcase temperatures are similar to a 4 stroke's crankcase temperatures, not elevated by the higher temperature of the Power cylinder.

FIG. 13 details the CMAHE in combination with the PTP. Although it is not its primary purpose, this allows a desirable heat exchange to also occur in the PTP. Otherwise, the CMAHE consists of a conventional exhaust valve, with exhaust flowing through a chamber with coiled or folded metal compressed air tubing, probably stainless steel to handle the temperature, pressure and chemical environment. The afterburner chamber exhausts to the exhaust system containing multiple insulated LCEHEs, as in Patent A. Tubing connects FPL to PTP fill valve.

FIG. 14 shows conventional automotive valves which perform a high pressure seal only in one direction. Where a need exists to seal against pressure from two directions, either a different type of valve, or conventional valves paired back to back will provide bi-directional pressure seal.

### DETAILED DESCRIPTION OF THE INVENTION

BL engine: The first is an engine which divides the cylinder functions into power cylinders, and compression cylinders. This engine has all the same strokes as a 4 stroke engine, in a 1 to 1 correspondence, but the compression pistons only do an air intake stroke and a compression stroke. The power cylinders only do a power stroke and exhaust stroke. This facilitates an opportunity to add heat and pressure to the air between the compression stroke and the power stroke. Just as in the 4 stroke engine, for each power stroke, there is exactly one compression stroke. Each power stroke of a 4 stroke engine provides the force to do a net of one compression stroke, although timing may spread this out among several other cylinders. The constant is 1 power stroke provides power to do 1 compression stroke, and what power is left over is the effective power output of the engine. Just as in a 4 stroke engine, the first engine design has the same balanced force relationship between compression and power strokes, hence is named the “Balanced Load” engine or BL engine. The Compression stroke is exactly balanced by the Power stroke, simultaneously. A BL engine has the same number of cylinders as an equivalent horsepower 4 stroke engine.

KLE: The second engine also has power cylinders, but has no compression cylinders. Compression is done by an external compressor device, still powered by the engine. A separate compressor can be smaller than the compression cylinders occupying a water cooled block. Compression does not require cooling and has approximately one forth the pressure handling requirement of a 4 stroke cylinder. Additionally, other compressor technology, scrolling, two stage pistons, etc. can produce more compressed air while consuming the same amount of power as the single stage piston compressors. Compression load is dynamic, and on average will be similar to the load in the BL engine.

The average kinetic energy from each Power stroke to provide compression is constant, but the compression load on any specific Power stroke may vary. One may want to temporarily turn off the compression load, relying on stored compressed air, such as at startup. This engine type is named a Kinetic Load Engine or KₑLₗE_{y} The KₑLₗE_{y} decouples the compression load from synchronization with Power strokes. The KₑLₗE_{y} has half as many cylinders, and half the displacement, of an equivalently powered 4 stroke engine. It has in addition an air compression mechanism other than synchronized single piston compression. Having a separate compression source allows a constant input pressure to be input in to the Fluid Pressure Ladder (FPL) portion of the Thermal Pressure Multiplier (TPM). This removes the velocity limit imposed by a synchronous compression piston. An FPL cycle may complete faster than an engine stroke, since it is only limited by the rate of compressed air flow. Otherwise, a compression stroke would need to complete in order to complete the FPL/TPM valve cycle.

Compression energy: Just as in 4 stroke engines, the energy used in compression is almost completely returned by each Power stroke. Both new engines allow the Power stroke's air to be pre-heated up to the exhaust temperature while under compression before any fuel is added. The initial temperature and pressure in an ideal embodiment will be the same as the compressed exhaust would be, and will have a fresh unspent source of oxygen. The fuel added must be reduced so that the final temperature and pressure are at the target determined to provide the desired engine power output. In other words, the thermodynamic cycle achieved is exactly the same cycle as a comparable 4 stroke engine.

A note about compression heating. While heating occurs during initial compression of ambient air, this is not a source of the thermodynamic cycle's energy, but a precondition. It is not a distinguishing factor among the 4 stroke engines and the BL engine or KLE. So in the following discussion, compressed ambient air is treated as being at ambient temperature, as the compression heating is irrelevant.

Piston Cycles: The 4 strokes engine cycle is based on a precondition of ambient pressure and temperature air compressed to the engine's compression ratio during compression stroke. Then fuel is added and combusted, raising the temperature of the compressed air. At maximum engine output, temperature is raised by about 3 times ambient, creating an absolute temperature of 4 times ambient. Engine cycles near idle have a much smaller temperature rise, scaling everything down. The maximum cycle illustrates the process better. After combustion, 4 times ambient temperature also creates 4 times initial conditions pressure. So for a compression ratio of 10 (typical), preconditions are 10 Atmospheres and post combustion is 40 Atmospheres. For a 6.7 square inch piston at top dead center, initial force is about 150 psi*6.7 or 1000 pounds, post combustion force is about 600 psi*6.7 or 4000 pounds. The 3000 pound difference is the source of engine output, the first 1000 pounds simply offsets another cylinders compression cycle. After the power stroke, about 35% of the heat energy which was added by combustion is converted to motion. The remaining energy is still there, and will be at about 3 times ambient. That is, combustion added 3 times ambient to total 4, ⅓ of the 3 added ambient units were converted by the thermodynamic cycle, and ⅔ of 3 added ambient units remain, leaving the post power stroke temperature at 3 times ambient. No energy is lost. 3 times ambient, or about 600 degrees C., or 1100 degrees Fahrenheit, is the temperature available for recycling. This is much higher than 4 stroke tail pipe exhaust temperature. Water cooling, a radiator, engine and exhaust system are all designed to radiate this heat away rapidly, so tailpipe exhaust doesn't ignite everything it touches.

differences with 4 stroke engines: What is different about the BL engine and KLE, are the preconditions to ignition. In a maximum engine power cycle, the 600 degree C. exhaust has its heat and temperature transferred to the incoming compressed air. Instead of 10 Atmospheres at ambient temperature, the initial condition is 30 Atmospheres at 3 times ambient. It is only necessary to add ⅓ the fuel to combust to bring final temperature and pressure up to 40 Atmospheres and 4 times ambient. So the same thermodynamic cycle is achieved with ⅓ the fuel. Post Power stroke, the temperature is again down to 3 times ambient. The heat and temperature are exchanged with incoming ambient air, so the tail pipe exhaust exits at ambient, and the next cycles initial conditions are at 3 times ambient. The oxygen from ⅔ of the fuel which would have been consumed in a 4 stroke engine remains unconsumed in the tail pipe exhaust. This is true for an ideal embodiment, no water cooling, no radiating surfaces on the engine or exhaust system. Internal cylinder temperatures at maximum output would stabilize at about 600 degrees C. 600 degrees C. is well within safe operating temperatures for steel. Steel's melting point is over 1500 degrees C.

After combustion, each Power stroke begins with the same pressure, temperature and mass of air in 4 stroke engines and both new engine types. The only difference is that less oxygen will have been spent in combustion, so comparatively the exhaust will be oxygen rich. This will enable combustion to be more complete, and enable CO and unburned hydrocarbons to be completely consumed without adding more oxygen. A catalyst may still be needed to aid in complete combustion.

Since the thermodynamic cycle is the same, each new engine type's Power stroke will produce the same power per stroke as a comparable 4 stroke. The fuel used is only sufficient to raise the Power cylinders air from exhaust temperature to post combustion temperature. The point here is that the entire fuel consumption's heat energy is converted in the next Power stroke's thermodynamic cycle.

Fuel conversion efficiency: The efficiency of the engine's fuel conversion is now decoupled from the efficiency of the thermodynamic cycle. Whether it's a 10% conversion or a 35% thermodynamic conversion, all the remaining energy is captured in an ideal embodiment. An ideal embodiment treats heat as fuel, and would not include water cooling or radiating surfaces. It would include thermal insulation so heat cannot escape, both on the engine and the exhaust system. The efficiency of heat recapture depends on the quality of insulation and heat exchangers. Over 90% efficiency is achievable with the same cost engine as current 4 stroke engines. The sheer mass of the block, the water cooling system, radiator, water pump, catalytic converters are traded for lighter insulation and heat exchangers. An ideal embodiment is thermodynamically cooled. The internal Power cylinder, TPM/PTP-pressure transfer piston and FPL-fluid pressure ladder temperature will track the average temperature of the exhaust - as it exits Power cylinders. The fluid pressure ladder and heat exchangers will have a temperature gradient from exhaust down to ambient. Internal cylinder operating temperatures will be elevated and materials must be chosen for higher average operating temperatures, at least in the Power cylinders and end stages of the thermal multiplier system (PTP, FPL, and heat exchangers). Typical operating power outputs of engines are much lower than at maximum power output. A 300 horsepower engine is rarely putting out more than 30 horsepower to maintain vehicle speed. So while the design must be able to run at maximum power output, typical internal engine temperatures will be much lower, generally less than twice ambient absolute temperature. Normal rise will be a fraction of ambient, much less than 2 times ambient.

An ideal embodiment is likely to be the KLE engine, as it uses less mechanical resources to do compression, so should be cheapest to manufacture in the long run. Incremental evolution from a 4 stroke engine would most likely be to a water cooled BL engine with a single heat exchanger stage. A single stage, shown in the drawings, can recapture significant portion of heat energy, and can also convert carbon monoxide into CO2. The heat of combustion of unburned hydrocarbons and CO is captured for conversion to motion.

Heat exchangers: How much is enough heat exchanger? Patent A shows a folded exhaust tube with integral counter flow heat exchanger, one sized for the engine compartment, another sized for the undercarriage. The undercarriage design allows for a folded exhaust tube hundreds of feet long, in basically the same space existing exhaust system occupy, under the passenger and luggage compartments. Are hundreds of feet necessary? Probably not. All cars already have a heat exchanger designed to handle the engines full heat output, the radiator. A one to one exchange in function and size will produce a heat exchanger system for the TPM with the same heat exchange rate as a radiator. This may only hit 70% or 80% efficiency, but it is certainly going to be close to an ideal heat exchanger size. The radiator proves the feasibility of heat exchanger capable of exchanging an engines waste heat and fitting in a vehicle.

A third device which is a component of both engine types is the carbon monoxide afterburner/heat exchanger (CMAHE). Combustion works best at elevated temperatures, which speed chemical reaction. The afterburner combines a heat exchanger, to recapture heat of combustion of CO. It is located immediately adjacent to the exhaust valve of the Power cylinders, to produce a peak heat for heat exchangers slightly higher than exhaust temperature. Catalysts may be used as in current catalytic converters, but may not be needed. The exhaust will have at least two thirds of its oxygen supply available, and at high temperatures continued CO and hydrocarbon combustion should occur spontaneously.

Air/fuel mixture: Both engines do air injection, as opposed to air intake into the Power cylinders. Consequently the process is much faster, and there is more control of the shape and dispersal of the compressed air. Some 4 stroke engine designs attempt to create air movement or vortex from the intake stroke. They are limited by working with a fraction of one Atmosphere of pressure. The TPM produces many atmospheres of pressure, so virtually any post injection air flow can be set up, rotating, counter rotating or turbulent for example.

Ignition: Both engines will have a “normal” Power stroke beginning with highly compressed heated air. Fuel injection into this state will normally yield spontaneous combustion, also known as dieseling. Since both air and fuel can be injected at the same time, complete control of the combustion fuel/air mixture is available by combined design of both injectors. Ignition during cold startup will require spark.

Starting: During a cold startup, a spark will be needed, since initial state of the power piston will be cool air at normal compression ratio pressure. Temperature will rapidly stabilize at average exhaust temperature, within a few seconds. Unlike water cooled engines all that is being heated is the exhaust system. There is no large thermal mass of water or engine block.

Starting of the BL engine can be the same as 4 stroke engines. Current electric starters are sufficient.

Because the KLEngine does not have compression cylinders, there are multiple ways to start the engine. The compressor will need to be able to pressurize air input prior to engine start. The air input should be designed to remain pressurized, with some storage, so typical startup will not require any air compression to occur first. The KLEngine could be rotated by a much smaller starter motor, so a simply smaller version of a starter motor can be used. Alternatively, the KLE can be started by air stored pressure. If electronic valve control is available, the engine can be started by cycling the air input valves, force pistons to a starting position, and pressurize a power cylinder. Fuel injection and ignition can begin immediately after. The KLE can start faster than 4 stroke or BL engines because it has no compression cylinders to oppose starting rotation. Compression load can be delayed till engine is running. For the same reason, minimum idle speed should be much lower, just enough to overcome mechanical friction and smaller continuous compression load.

Controlling engine power, given the engine stores energy: Both engine types will store energy in the form of compressed air and heat in the Thermal Pressure Multiplier system. Simply reducing fuel to zero may allow the engine to continue running, producing significant but diminishing power, for several seconds to tens of seconds, depending on the compressed air volume of the TPM. Several alternatives exist to keep the engine from producing unwanted drive power immediately after the driver signals (via accelerator pedal) to stop. One would be to divert the engine output into stored electricity, as in a hybrid. Another is to halt valve cycling, leaving exhaust valves (and intake valves of BL engine) open. The engine and crankshaft can then freewheel due to momentum, and may even come to a halt. With the TPM valves closed, the stored energy will remain there until valve cycling resumes. This presumes more sophisticated valve control, probably electronic valves, but can change engine output almost immediately. This method will also preserve stored energy in the TPM between periods of engine power demand.

Frictionless energy conversion: The ideal embodiments are effectively frictionless with regard to energy conversion. They are NOT frictionless, nor do other impacts of friction go away, such as its impact on power output or wear. Friction does not lose energy, it converts energy into heat. With an ideal embodiment, the pistons are thermally insulated to retain heat, so there are only two escapes for heat. One escape is thermodynamic conversion to motion, the desired result. The other is through cylinder exhaust. The TPM will recapture heat leaving the cylinders through exhaust, so the energy turned into heat by friction recycles to heat the working fluid (air) for future engine cycles. Friction will not impact the energy conversion efficiency of a mature embodiment of either of the engines described here.

Safety is a concern when dealing with elevated temperatures. The ideal embodiment has thermal insulation around the combustion cylinders and exhaust chain. All exposed engine parts can be safely touched, unlike 4 stroke engines. 4 stroke engines are designed to radiate heat everywhere, making engine and exhaust unsafe to touch with bare hands. The ideal embodiments' tail pipe exhaust has most of the added heat removed, and will be at most warm to the touch. Insulation covers engine and exhaust pipes, so they can be safely handled. The cars engine compartment and undercarriage will also run significantly cooler. Exhaust will even contain significant unconsumed Oxygen, so while not safe to breath, definitely safer in chemical composition than a 4 stroke exhaust.

Zero-emission application. Zero emission generally refers to CO2 and any un-breathable emissions. While any internal combustion engine can be adapted to simply burn hydrogen, 4 stroke conversion efficiencies from 10% to 35% make that economically unsound. The usual hydrogen design is with a fuel cell to provide electricity from hydrogen, which can be converted to motion with better than 90% efficiency. Heat recycling thermodynamic engines such as these, with 90% efficiency, are directly comparable in fuel efficiency with a fuel cell, but the engine cost is as much as 100 times cheaper. While hydrogen is not a generally available fuel, it can be produced from zero emission sources from wind or solar. These engines make it possible to build a passenger vehicle for the same cost as current vehicles, which can run on hydrogen, when it becomes an available fuel. Unlike plug-in vehicle technology, hydrogen can be refueled rapidly, and has the potential of actually eliminating un-breathable emissions, instead of simply moving the emissions from the vehicle to an electric power plant.

1. Internal combustion engine capable of recycling heat.

2. Two subtypes of engines cited in claim 1, are BL engine and KLE.

3. Internal combustion piston engines cited in claim 1 are not an existing type of engine. neither 4 stroke or 2 stroke.

4. Engine type cited in claim 2, designated as BL engine, separates combustion cylinders from compression cylinders.

5. Engine type cited in claim 2, designated as KLE removes compression function completely from engine cylinders, leaving only combustion cylinders.

6. A device used in both engines cited in claim 2 which converts CO to CO2 and combusts unburned hydrocarbons.

7. Device cited in claim 6 reclaims chemical energy as heat.

8. Device cited in claim 6 recycles chemical heat via heat exchanger.

9. Devices cited in claim 2 can have theoretical fuel conversion efficiency limit of 100%.

10. Devices cited in claim 2 can practically be at least 90% efficient in fuel conversion.

11. Devices cited in claim 2 can reduce automotive fuel consumption by approximately two thirds.

12. Devices cited in claim 2 can reduce carbon emissions by approximately two thirds.

13. Back to back valve arrangement used in engines cited in claim 2 are capable of bi-directional pressure seal with conventional one directional internal combustion engine valves.

14. Device cited in claim 5 makes use of temperature insulated cylinder to prevent loss of heat energy.

15. Devices cited in claim 2 delay fuel injection until ignition time, allowing for air mixture to be preheated and or compressed to a degree beyond which spontaneous combustion would occur.
